(19) United States
(12) Patent Application Publication
(10) Pub. No.: US 2015/0305320 A1
(43) Pub. Date: Oct. 29, 2015

(54) PROCESS FOR HEAT TREATING BUILDINGS AND ARTICLES

(71) Applicant: ThermaPure, Inc., Ojai, CA (US)

(72) Inventor: David E. Hedman, Ojai, CA (US)

(73) Assignee: ThermaPure, Inc.

(21) Appl. No.: 14/695,962

(22) Filed: Apr. 24, 2015

Related U.S. Application Data
(60) Provisional application No. 61/983,830, filed on Apr. 24, 2014.

(51) Int. Cl. A01M 1/24; F26B 3/18; A01M 19/00

(52) U.S. Cl. CPC A01M 1/24; A01M 19/00; F26B 3/18

(57) ABSTRACT

A process for removing or treating harmful biological organisms and chemical substances from a structure by using heated air. The method of the present invention is non-toxic and can be performed in a relatively short amount of time while effectively killing and removing a large proportion of dead organisms and substantially reducing volatile organic compounds. A method for verifying the removal of the organisms is also provided. The invention can also be used to effectively treat water damaged structures.

### RELATED APPLICATION

This application claims priority to U.S. Provisional Application Ser. No. 61/983,830, filed Apr. 24, 2014.

### BACKGROUND OF THE INVENTION

The present invention relates to methods of sanitizing structures, buildings, passenger occupiable vehicles, and other enclosed or enclosable spaces. More particularly, the present invention relates to a method for killing and/or removing pests and their allergens and pheromones, bacteria, viruses, fungi, molds, volatile organic compounds and other dangerous substances, such as Mercury, and water intrusion from such enclosures.

It is a common problem that pests, such as insects and rodents, find their way into homes, hotels and other structures. For example, mice, rats, and other rodents often find access into a home or building through open doors, crevices, etc., and nest and breed within the house, particularly within the winter months. The presence of such rodents, or nesting birds or bats, can also introduce other pests into the structure. For example, fleas, lice and beg bugs often find their way into homes, hotels, etc., by transmission of birds and rodents which nest within the eaves or within the structure of the home or hotel.

There are at least seventy different kinds of bed bugs across the world. The blood-sucking parasites are wingless, dark reddish-brown, oval and flat insects. Full-size adults are typically less than one quarter inch long, and mature in about four weeks after hatching, if a host is available. Bed bugs can endure freezing temperatures and use a variety of hosts besides humans, including poultry, rodents, dogs, cats, birds and bats. Although humans rarely feel the approximately fifteen-minute-long bite, some people show sensitive reactions to it. An indication of bed bugs is small blood spots on bed sheets. Bed bugs hide in cracks and crevices during the day, and come out at night to feed. They are found around mattresses, behind picture frames, in night stands, stuffed furniture, behind loose wallpaper, and other enclosed spaces. They will crawl a substantial distance to obtain a blood meal.

Bed bug infestation is particularly problematic for hotels and multi-tenant housing complexes. When the presence of bed bugs is found, such as by blood stained sheets, the problem must be addressed very quickly, otherwise, the reputation of the hotel or complex will be in jeopardy, causing lost business and profits. Current protocols for killing bed bugs can take several days. Even once the treatment is completed, pheromones from the bed bugs (or other insects or rodents) linger for several days or even a week or longer. Thus, when the treated rooms or complex is tested for the presence of these pests, such as by utilizing trained canines, it is difficult to know whether there is a false positive or the treatment has been adequate. During this time, hotels are unable to offer these rooms to guests and multi-tenant managers must put the tenants up in temporary housing, which presents high costs to these businesses.

In desert settings, it is not uncommon for scorpions to infest homes, and occasionally sting unsuspecting adults or curious children or animals. The scorpions gain access to the dwelling through holes or crevices in the house and are attracted to the moisture and cooler temperatures.

A large number of methods have been developed for killing insects, such as termites, in buildings. The most widely used method is tenting the building, then filling the building with a toxic gas for a period of time sufficient to kill termites or other selected insects. This method is effective for killing termites and other insects. However, this method generally requires as many as four days to be effective, requiring building occupants to move out and businesses to be closed for approximately a three day period to insure proper venting of toxic material and/or gas. Tenting the building with heavy tarpaulins requires workers to walk and arrange the tarpaulins on the roof, often damaging the roof system. Food and medications must be placed in sealed containers or removed. Generally the entire building must be treated, even if the infestation is localized.

Techniques of varying effectiveness have been developed using heated air or very cold air to kill termites and other organisms. Typical of these are the methods disclosed by Charles Forbes in U.S. Pat. No. 4,817,329, in which wood destroying insects, e.g., termites, are killed by applying a heated gas, such as heated air, to wooden surfaces or the like until the core of wooden structures is heated to a temperature typically about 120° F. to 135° F. This method has been found to be very effective for killing termites. Another alternative to the toxic gas method is disclosed by James J. Chaudoin, et al. in U.S. Pat. No. 4,958,456, in which insects, e.g., roaches, fleas and beetles, are killed by a treatment of building spaces with boric acid and heat. However, the methods disclosed in the Forbes patent are quite complex in the preparation of the building. An enclosing tent structure must be formed around the building to be decontaminated, as the termites and wood eating insects are typically found in the framing, shingles, and outer panels of the building. Tenting the building with heavy tarpaulins requires workers to walk and arrange the tarpaulins on the roof, often damaging the roof system.

Other organisms, such as bacteria, viruses, fungi, and molds such as, but not limited to, aspergillus oryzae, aspergillus terreus, aspergillus versicolor, cladosporium hergbarum, stachybotrys chartarum, penicillium aurantiogriseum, pencillium chrsogenum, pencillium gladrum and fusarium oxysporum, are a serious health hazard even when dead. Many people are allergic to the dust-like remains and residue, i.e., allergens, of these organisms that can also cause serious health problems. This is a particular problem to persons suffering from asthma, bronchitis, pneumoconious and other respiratory ailments, and is a common contributing factor to sick building syndrome (SBS).

It is also well-known that the heated air causes certain molds, fungi, etc. to sporulate, thus releasing spores into the structure and thus dispersing the harmful biological agents and possibly contaminating the structure to a greater degree than originally presented. The use of positive pressure within the structure, as described in Forbes et al., further increase the likelihood that the biological contaminants will be dispersed throughout the structure. Forbes also discloses that the heated air can be vented from open windows and the like. However, when treating a contaminated building having harmful viruses, toxic molds, etc., it is not desirable to release such contagions into the air.

Volatile organic compounds (VOCs) have also been implicated as a possible cause of SBS. VOCs can originate from a variety of sources. Commercial examples include by-products of printing shop operations, office machine repairs, blueprint production, photographic processing and food service operations. In residences, such VOCs can include hobbyist products, cosmetics, perfumes, personal hygiene products, aerosol sprays, tobacco smoke, pet urine and even small emissions from the bodies of the occupants. Off-gassing of VOCs is often a common by-product of various building/construction materials, for example paints, adhesives, plastics, carpeting, etc.

Such VOCs are implicated with SBS for mostly two reasons. First, the health effects from exposure to VOCs are consistent with SBS, ranging from irritant effects such as unpleasant odors and mucous membrane irritation, through general systemic effects such as fatigue, nausea, and difficulty concentrating. In addition, they may be of importance because some of them have been shown to have carcinogenic or adverse reproductive effects. Second, indoor concentrations of VOCs, particularly in new buildings, are often greatly elevated with respect to outdoor VOC concentrations. In fact, indoor VOC concentrations have typically been found to be two to ten times higher than outdoor concentrations, and indoor concentrations as much as 100 times higher than outdoor concentrations have been reported in new buildings.

In the northeastern parts of the United States, it is common for heating oil to be delivered and used in the heating of the home during the winter months. The oil can spill, and the fuel oil fumes and odors can infiltrate the house over time and contribute to SBS.

Passenger occupiable vehicles, such as trains, buses, airplanes, etc. also include building/construction materials which are known to off-gas VOC's. Also, the fuel, oil, and grease fumes and odors can infiltrate the passenger compartments of such vehicles and build-up within the seats, carpets, etc. over time. Due to the great number of people regularly traveling in such vehicles, there is an increased chance of coming into contact with contagious bacterium or viruses that can cause illness. Other organisms, such as fungi, and toxic molds can also be potentially found in such vehicles. As the company owning such vehicles necessarily must keep the vehicles running nearly constantly in order to realize the expected profit, such vehicles are rarely cleaned thoroughly. Even if the surfaces are superficially vacuumed and wiped down, there still remain live and dead organisms such as lice, mites, fungi, toxic molds, bacterium, viruses, VOCs, oxidized odors, and potentially insects which may have infested the vehicle, particularly those where food is prepared or served.

The dangerous side effects of mercury poisoning are increasingly becoming realized. Mercury is so toxic that even the breaking of a thermometer is considered an emergency response situation requiring the fire department to be called to the location. The complete and proper removal and disposal of the mercury is very important.

Water intrusion due to storms, floods, broken pipes or backed up sewer lines can cause significant damage to buildings and other structures. Even when the free-standing water is removed, many of the building materials such as sheet rock, framing lumber, carpets, etc. retain a high level of water and moisture therein. If this is not quickly and properly treated, fungi, mold and bacteria can grow in these wet areas. These microorganisms can cause adverse health side effects. It has been found that merely blowing or otherwise circulating air in the affected area and even heating the area is not an ideal solution to quickly removing the water and moisture from the structure. This is particularly the case when one area of the structure has been water damaged while another area of the structure has not.

Accordingly, there is a need for a system and method for killing and removing biological organisms and reducing odors and volatile organic compounds in enclosures such as commercial and residential buildings, boats, vehicles and portable containers. Such a method should be non-toxic and performed in a relatively short amount of time. Such a method should also effectively kill and remove a large proportion of the dead organisms and substantially reduce volatile organic compounds. There is also a need for a method which can remove moisture from water damaged structures. Moreover, there is a need for an effective process for verifying the efficacy of such treatments. The present invention fulfills these needs and provides other related advantages.

### SUMMARY OF THE INVENTION

The present invention resides in a process for removing or treating harmful biological and chemical substances from a structure, such as a building or vehicle by using heated air. The method of the present invention is non-toxic and can be performed in a relatively short amount of time while effectively killing and removing a large proportion of dead organisms, and substantially reducing volatile organic compounds and other dangerous substances, such as Mercury.

Ambient air within the enclosure is heated to a temperature between 100° F. and 400° F. This may be done by placing and distributing air into the enclosure using a heater passing heated air through a duct into the structure. Alternatively, a heating device, such as an electric heater or liquid-to-air heat exchanger device can be placed within the enclosure. A plurality of temperature probes may be positioned at predetermined locations relative to the enclosure to monitor the temperature in the enclosure until the predetermined temperature is achieved.

In accordance with the present invention, electric heaters that require a high amount of electricity or wattage may be used. Alternatively, multiple electric heaters, fans, and other electronic devices may be used to perform the invention. In some cases, in order to provide sufficient power to these electric devices, a plurality of portable electric generators are placed in series with one another in order to generate sufficient electricity to power the one or more heaters and other electrical devices performing the invention.

The pressure and elevated temperature increases the volatilization or vapor pressure of the chemical substances, including mercury, causing them to migrate into the ambient air. This also kills the harmful microbiological organisms. Preferably, the air within the enclosure is aggressively moved, such as by using blowers or fans, so as to facilitate the volatilization of the microbiological organisms and chemical substances into the air. Such chemical substances can include volatile organic compounds, oil, or chloroanisole compounds. Microbiological organisms killed by the process of the present invention include fungi, molds, viruses or bacteria. The blowers and fans also improve heating of the enclosure. The biological organisms and chemical substances may be removed from the heated air by either incinerating them, or passing the heated air from the enclosure through a filter adapted to capture the microbiological organisms and chemical substances.

Depending upon the nature or concentration of the chemical substances or organisms to be removed, the heated air may be passed through a filter adapted to capture the organisms and chemical substances. Preferably, the air within the room is aggressively moved to facilitate the volatization of microbiological organisms and chemical substances into the air. The room may be vacuumed with a HEPA vacuum and most surfaces wet wiped or cleaned to remove pheromones for immediate clearance by canines.

In addition to the chemical substances and microbiological organisms mentioned above, this embodiment can be used to kill and remove other pests such as bed bugs or fleas. In accordance with the present invention, ambient air within a structure is heated to a temperature of between 100° F. and 400° F. to kill the pests or drive them from the structure. Metallic salt may be applied to areas within the structure which are infested with the insects within the pests, and particularly insects or microorganisms, in order to facilitate the killing of these pests and microorganisms.

The air within the structure may be heated by distributing heated air into the structure using a heater passing heated air through a duct into the structure and/or placing a heater device within the structure. High pressure, heated air may be blown into cracks, crevices and voids as well. This may be done, for example, using a vortex tube, to inject the hot, pressurized air into the cracks, crevices and voids. One or more temperature or moisture probes may be placed at locations to monitor the temperature in the structure until the temperature is between 100° F. and 400° F. is achieved. A biocide or metallic salt may be applied and disbursed within the structure prior to the heating step, or even after the heating step.

For example, the present invention can be used to kill bed bug insects, including a portion of a multi-unit building. The portion may be a room and adjacent rooms of a hotel or the like. First, it is determined which discreet portion of the multi-unit building is infested with the bed bug insects. The determination of the locations of the insects or rodents or other pests within the structure may be performed using attractants. The one or more areas of the structure where the insects or rodents and other pests are located is then treated. Ambient air within the infested discreet portion or room is then heated to a predetermined temperature of between 110° F. and 400° F. for sufficient time to kill the bed bug insects. Preferably, at least the infested room and the rooms adjacent to it, totaling less than all the rooms of the hotel, are treated with the heated air. Temperature probes are positioned as necessary, such as in a bed of the infested room to monitor the temperature. Heat-sensitive articles may be protected or removed from the infested area.

The present invention also provides a process and method for removing insect and rodent pheromones from the treated structure so that false positive testing is avoided and the structure or rooms within the structure or rooms within the structure can be more quickly occupied and used. This includes cleaning surfaces within the structure to remove pest remains and pheromones from the surfaces. This may comprise the step of wiping surfaces within the structure to remove pest remains and pheromones from the wiped surfaces. A vacuum having a filter capable of trapping pest pheromones may also be used to clean the surfaces. Air from the treated structure may also be passed through a filter and/or reactor that degrades or destroys the pheromones. This may be done, for example, by creating a negative pressure within the structure and passing the air of the treated structure through a filter or through the reactor. The treated area of the structure is then tested for the removal of the pheromones and/or insects or rodents from the treated structure. This may be done, for example, using a canine to test for the removal of the insects, rodents or pheromones from the treated structure and/or a gas chromatograph.

The present invention can also be used for removing moisture from a water damaged structure. A temperature and pressure differential is created between adjacent first and second areas of the structure by heating ambient air within the first area of the structure to a temperature of between 105° F. and 400° F. This may be done, as described above, by distributing air into the first area of the structure using a heater passing heated air through a duct into the structure or a heater device within the structure. This may also comprise directing heated air into wall cavities or soffit voids to reduce moisture through evaporation. A vortex tube may be used to inject the hot, pressurized air into the cracks, crevices, soffits and voids.

The temperature in the first and second areas is measured and monitored, such as by positioning one or more temperature and/or moisture probes at locations to monitor the temperature or moisture content of the air. Moisture from a boundary of the first area to the second area of the structure is transferred as cooler air in the second area comes into contact with heated air or building materials of the first area of the structure, causing the air in the second area to heat and draw moisture therein. The temperature or pressure may be altered to maximize the transfer of moisture from the first area to the second area of the structure. The moisture from the air of the second area is removed by evacuating from the second area from the structure and/or passing the air from the second area through a dehumidifier or desiccant.

The invention may also kill microorganisms resulting from the water damage with the heated air. Furthermore, a biocide or metal salt may be applied to areas of the structure contaminated with such microorganisms.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic diagram showing various components of the system of the present invention installed for treatment of a building;

FIG. 2 is a flow-diagram illustrating the steps taken in the method of the present invention;

FIG. 3 is a cross-sectional and diagrammatic view of a vortex tube, used in accordance with the present invention;

FIG. 4 is a schematic diagram showing various components of the present invention, including a heat exchanger device installed for treatment of a building;

FIG. 5 is a schematic diagram showing components of the present invention, including an electric heater and portable generators installed for treatment of a building;

FIG. 6 is a schematic diagram showing various components of the present invention installed for treatment of a building infested with pests, such as insects, and the determination of an ingress/egress point in the building;

FIG. 7 is a schematic diagram showing various components of the present invention installed for treatment of pests in a single room of a building, where the pests have been located in that room, in accordance with the present invention.

FIG. 8 is a schematic diagram of a multi-unit building having at least one room infested with pests, such as bed bugs;

FIG. 9 is a schematic diagram similar to FIG. 8, showing various components of the present invention installed for treatment of the pest infestation in one or more rooms of the multi-unit building; and

FIG. 10 is a schematic diagram showing various components of the present invention installed for removing moisture from a building, in accordance with the present invention.

### DETAILED DESCRIPTION OF THE PREFERRED EMBODIMENTS

As shown in the accompanying drawings for purpose of illustration, the present invention is related to a system and method for treating structures, such as buildings and enclosures. In accordance with the present invention, heating of the air is primarily used to treat such enclosures and buildings so as to remove and/or denature harmful organic substances, such as VOCs, microbiological agents such as bacteria and viruses, and pests such as rodents, bed bugs, and other insects and their allergens and pheromones from an enclosure.

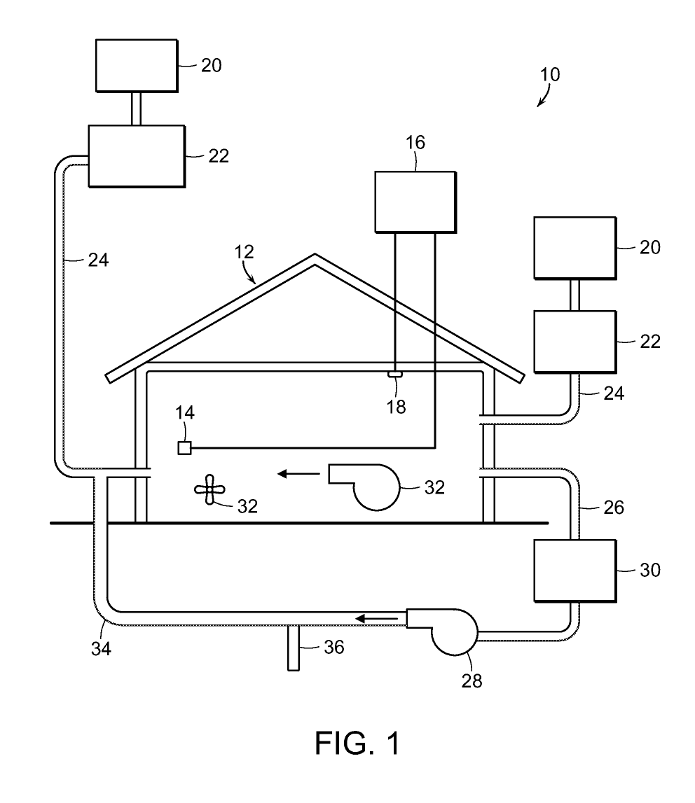

Referring now to FIG. 1, there is seen a schematic diagram showing the components of the system of the present invention, referred to generally by the reference number 10, in use treating an enclosed structure 12. The enclosed structure 12 is typically a commercial or residential building, but can also be a vehicle, such as an airplane, bus, boat, automobile, etc.

A plurality of temperature sensors 14 are positioned at predetermined locations within the structure to monitor the temperature of the structure 12. Typically, these sensors 14 have thin, elongated tips that can be adhered to or pushed into materials to be heated or into suitably sized holes drilled into such materials so as to measure the surface and/or internal temperature. The sensors 14 may be wired to a console 16 which displays and records the temperature at each sensor 16 in real time. Alternatively, the sensors 14 may be wireless and transmit a signal to the console 16. Typical sensors 14, as by way of example and not by way of limiting, include thermal couples, thermistors, or the like connected to a computer and/or a strip chart recorder console 16.

A pressure measuring device, such as a manometer 18, may be positioned within the structure 12 so as to measure the internal pressure of the structure 12 during operation of the invention. In some instances, positive air pressure is desirable, however, in most instances, a negative pressure is established and maintained throughout the operation of the method of the present invention in order to prevent the dispersal of harmful biological and organic contaminants throughout the structure 12. The manometer 18 can be linked to the console 16 to provide the pressure information from without the structure 12.

One or more heaters 20 heat air to a predetermined temperature lethal to the organisms to be destroyed, with optimum results generally achieved with temperatures in the range of about 100° F. to 400° F. For a more complete disinfection, the air temperature is preferably raised to at least about 155° F. Any suitable heater 20 may be used. A gas burning heating device 20, such as a conventional propane heater, is preferred as being particularly efficient in heating air. Any other heating arrangement, such as oil heaters, electrical devices, solar heaters, and light emitting devices, may be used if desired.

Heated air (and biocide, if used) from the one or more heaters 20 is directed through blower 22 (which may, if desired, be a component of the heater 20) which injects the hot air into the enclosed structure 12 through at least one inlet duct 24. Generally, a plurality of inlet ducts 24 will be used to achieve the optimum distribution of hot air throughout the enclosed structure 12. The inlet ducts 24 preferably include variable flow dampers and may be moved while the system is in operation to achieve uniform temperatures in all areas of the structure being treated, as sensed by sensors 14 and observed at console 16. While external heaters 20 are shown in FIG. 1, it will be appreciated that the heaters 20 may be disposed within the structure 12. This is particularly the case when electric heaters are used. However, heaters which burn fossil fuels could also be disposed within the structure 12.

At least one outlet duct 26 is provided to allow the air to be removed from the structure 12. A blower or vacuum 28 is connected to the outlet duct 26 in order to remove air from the interior of the structure 12. Vacuum 28 may be used to create a negative pressure within the structure 12. Typically, this negative pressure is created before the heated air is introduced into the structure 12. The removed air is filtered, typically utilizing a high particulate arrestance filter, ULPA filter, or the like coupled with the vacuum/blower 28. Other filters such as charcoal filters or UV filters may be employed as well. Additionally, or alternatively, the air which is removed from the structure may be heated to very high temperatures so as to incinerate or otherwise neutralize the potentially harmful chemicals and microbiological organisms which have volatilized into the air. The filter or air scrubber 30 removes the remains of the organisms and VOCs from the air to prevent them from reaching the environment or being re-introduced into the structure 12.

Preferably, additional blowers 32 or fans are positioned within the structure 12 to aggressively move the air within the structure to further enhance the removal of harmful biological and organic substances by volatilizing the microbiological and chemical substances and aid in heat distribution.

Additionally, fans 32 may be positioned strategically within the structure 12 to selectively move the air away from predetermined heat-sensitive articles or areas of the structure in which such an elevated temperature is not desired. Typically, however, such heat-sensitive articles are removed from the structure or covered with insulation mats or the like.

The filtered air may be redirected through duct 34 into the structure 12, such as by linking duct 34 with inlet 24. Such re-circulation of heated air enhances the energy and thermal efficiency of the process and decreases the overall treatment time. Recirculating has been found to increase air circulation within the containment area of the structure 12. The re-circulated air may be blended with the heat processed air as it exits the heater, re-heated by the heater 20 or simply re-introduced by way of ducting into the structure 12.

It will be appreciated by those skilled in the art that the present invention, as described above, can be used in a variety of scenarios. For example, in the event a building is infected with viruses or bacteria, such as a hospital, an individual's house which has been contaminated with a lethal virus or bacteria, an office building which has been exposed to bio-terrorism or the like. The building may be simply de-gassed to remove VOCs and reduce the potential for SBS in the employees or occupants thereof. In such instances, when a dangerous chemical or microorganism is being removed from the enclosure, it will be appreciated that they cannot be simply released into the atmosphere. Instead, the filters and incinerators must be used to destroy, neutralize and contain these organisms and substances and prevent their release into the environment. However, in other cases, venting to the atmosphere is possible, such as when removing VOCs and the like.

The present invention, as described above, can also have various other specific applications. For example, in the northeastern portions of the United States, fuel oil is typically used to heat homes and other structures. Often, spills occur during the fueling process. These fuels are difficult to clean, and sometimes the fuel oil penetrates into building components. Other harmful substances, such as mercury, are sometimes inadvertently spilled, such as when a thermometer breaks. The present invention can volatilize and remove these spills.

The removed air can be sampled in order to determine if the level of contaminants in the heated air. For example, an outlet 36 may be installed in the ducting 34 or 26, and a gas chromatograph or a like device can be used to determine the levels of the contaminants before, during and after the heating process of the invention. This can be used in determining the period of time necessary to treat the structure. When the contaminants, such as VOCs has fallen below acceptable limits, the process can be terminated.

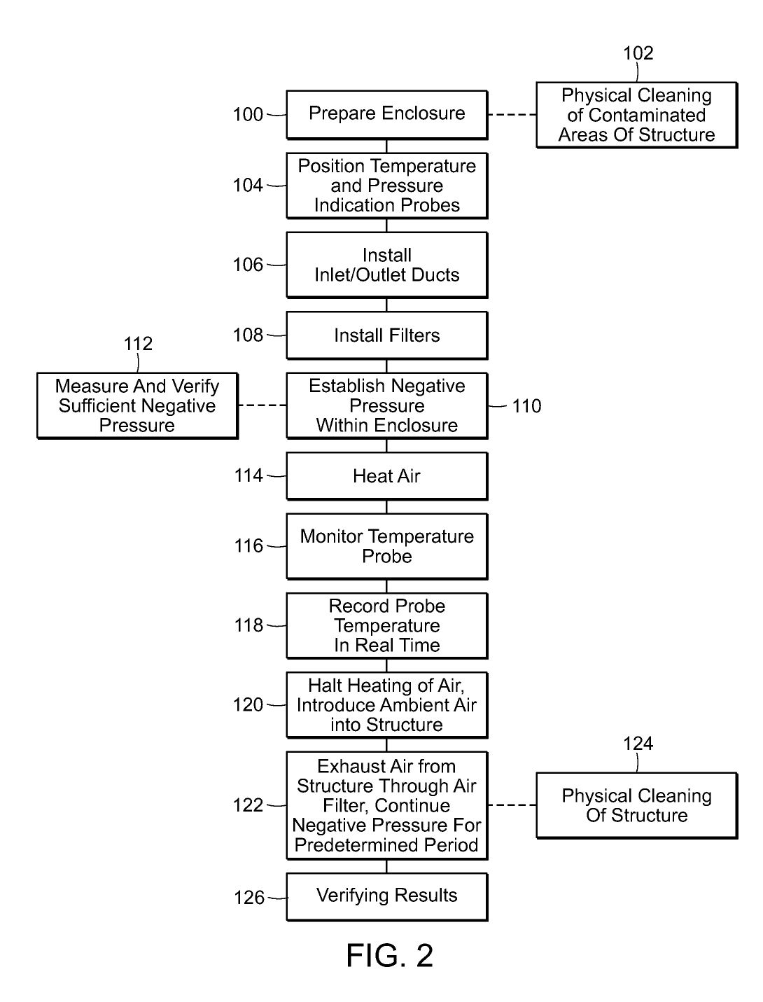

With reference to FIG. 2, in the operation of the system of the invention, the first step is to prepare the structure, as indicated in block (100). This basically involves removing heat-sensitive items from the enclosure or, in some cases, covering heat sensitive items, such as electronic devices and plastic items, with thermal insulation material. All material that has a flash/melt point at or below the maximum temperature to be used (such as candles, lipstick, etc.) should be removed.

Typically, the preparation of the structure also includes physical cleaning of contaminated areas of the structure (102), which may be performed while the area is under a negative pressure. This can include vacuuming, wiping, scraping, etc. of various surfaces which have been contaminated with harmful biological contaminants, such as mold, fungi or bird, rodent or insect debris, etc. In extreme cases, this may require the removal of carpeting, section of walls, etc. However, the invention is intended to neutralize and remove these biological and chemical contaminants without requiring resort to such extreme measures in most instances.

In one embodiment, particularly when treating the structure 12 for mold, fungi, and insects, biocides and/or metallic salt, are dispersed within the structure 12 at locations, preferably, where mold and fungi or insects are likely to be encountered. Iron sulphate is an example of a metal salt. Iron sulphate has the chemical compound of FeSO4 and is often seen in the form of bright green crystals. The salts may be made from virgin metals, and/or include nickel sulphamate, nickel sulphate, nickel chloride, cobalt chloride, copper sulphate and cobalt sulphate.

Applying metallic salt may be done by conventional applicator methods and devices, i.e., metallic salt as a metallic salt insecticide dust, spraying a solution or slurry or dispersion of metallic salt, etc., coupled with heating the air within the enclosure, advantageously improves mold, fungi and pest abatement within the structure 12. The borates may be used in pre-treating contents of an enclosure or in post-treating such contents after application of heat.

A plurality of temperature indicating and pressure measuring probes 14 and 18 may be placed in predetermined locations as indicated in block (104) to assure that the required temperature levels are achieved. In some cases the probes 14 can be read directly, although preferably they are connected by wires or wireless means to the console 16, so that all probes 14 and 18 can be monitored conveniently and the data recorded in real time.

The enclosed structure 12 may be sealed and at least one inlet duct 24 and at least one outlet duct 26 installed as indicated in block (106). Generally, a plurality of inlet ducts 24 is preferred. Although each duct 24 may enter the enclosed structure 12 separately, the use of one inlet duct 24 connected to a manifold from which plural ducts extend to predetermined locations within the enclosed structure 12 is preferred. Ducts 24 may enter the structure 12 through any suitable opening, such as an open window or door with the remainder of the window or door blocked by a panel. In some instances, such as when treating vehicles, tenting may actually be required or desired to treat the structure 12. However, in most instances such tenting is not required.

The appropriate air scrubbing filters 30 and vacuum devices 28 for facilitating the removal of the heated air and filtering the harmful substances therefrom, are installed, as indicated in block (108).

When the components of the system 10 have been properly prepared and positioned, heated air is directed into the inlet ducts (110). A desired pressure may be established within the structure (112) and the manometer or other pressure sensing device is used to verify that a sufficient pressure is present. In some instances, a positive pressure is actually desired wherein the ingress of heated air flow into the containment area exceeds the egress air flow from the negative air machines 28. Such positive pressure may be desired to force the contaminants to volatize or otherwise enter the circulated air. Typically, a negative air pressure within the structure 12 is desirable, by removing air more quickly than it is introduced, to ensure the removal of the contaminants therefrom and to promote circulation of the air. This is accomplished using the vacuum/blower device 28 and filter 30 as described above. Using the pressure measuring manometer device 18, the internal pressure of the structure is measured and it is verified that sufficient negative pressure is present. Often the establishment of negative pressure is performed before any heat is introduced into the structure in order to begin the removal of any loose and aerosolized contaminants, and prevent their sporulation before heat is introduced.

The heated air is then introduced into the structure (114). Flow of the heated air through the enclosed structure 12 may range in time from a few hours to several days to provide optimum results. During this time, the temperature probes 14 are monitored (116) and these results recorded in real time (118) to ensure that the intended areas within the structure 12 are properly treated.

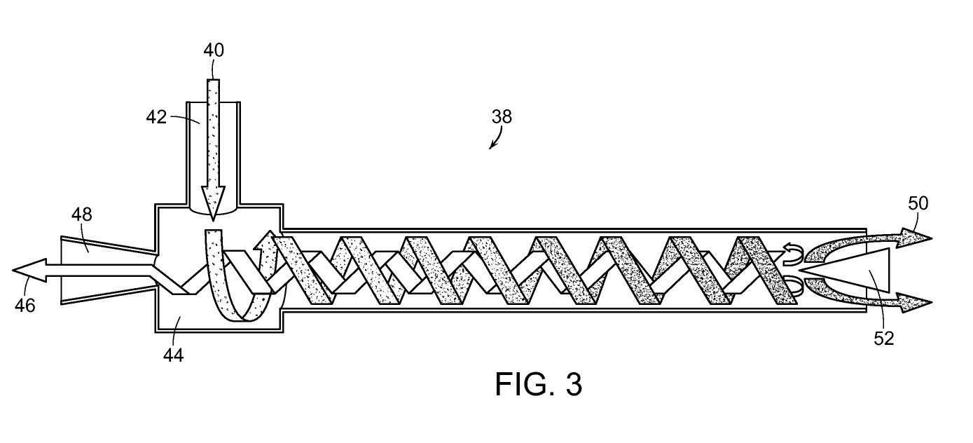

With reference now to FIG. 3, heated air may be directed into crevices, cracks, voids, soffits and the like in order to dry out these areas due to water damage, kill microorganisms, pests, including rodents or insects, residing therein. One means of doing so is by utilizing pressurized, heated air which is blown into the crevices, cracks, voids, etc. This can be accomplished, for example, by utilizing a vortex tube 38. The general operation of a vortex tube 38 is illustrated in FIG. 3, wherein pressurized air 40 is delivered through inlet 42 or is introduced into swirl chamber 44 and accelerated to a high rate of rotation. Cool air or gas 46 exits through enlarged outlet 48 through one end of the vortex tube 38, while heated air 50 exits a conical or restricted outlet 52 at another end of the vortex tube 38. The conical outlet 52 is of a reduced diameter, such that the remainder of the air or gas is forced to return into an inner vortex of reduced diameter within the outer vortex. Thus, the vortex tube 38 is a mechanical device that separates a compressed gas into hot and cold streams. The hot air emerging from the hot end or outlet 52 can be used to apply pressurized, heated air into specific areas of the structure, such as cracks, crevices, voids, soffits, etc. These are often the areas where mold, fungi, rodents, and insects reside. Biocides and/or metallic salts may also be applied to these areas to facilitate treatment.

The heated air which has been circulated through the structure 12 may be continually removed through an air scrubber, filter or reactor 30 to remove the remains of the destroyed microorganisms and chemicals, such as VOCs and pheromones. A reactor could generate a cloud of free radicals within the reactor to oxidize the molecules which will be recomposed into original air molecules. A free radical is a particle which has an oxidizing energy during a very short life. This provides a high capacity to cut the molecules (viruses, bacteria, odors, pheromones, VOCs and the like) and the free radicals are not released from the reactor. Biocides, such as ozone or even moisture, may be added to the heated air to enhance the treatment effect.

At any time during system operation, the inlet and outlet ducts 24 and 26 may be moved to assure uniform temperatures throughout the structure, as indicated by the temperature probes 14 and temperature monitoring console 16.

After a predetermined period of time in which it has been determined that the harmful biological organisms and agents have been destroyed, the heating of air is halted and non-heated ambient air may be introduced into the structure (120). The air from the structure is then exhausted through the air filter while the negative pressure is maintained for a predetermined period of time (122). These steps are taken in order to prevent any viable fungi, molds, etc. from sporulating or the like as such organisms when threatened with destruction will often sporulate or form cysts or the like to facilitate the survival of the organisms and their progeny. The aggressive air flow through the structure continues to remove the harmful microorganisms, chemical substances, etc., for some time.

This entire process may often be completed in as little as one to twelve hours, for example, allowing a business to be closed for only one day or a residential structure to be fully treated during a typical work or school day. However, in certain circumstances, such as in the case of large structures or high levels of harmful substances within the structure, the process may be extended to several days or more to ensure that the structure is properly treated. It has been found that while harmful organisms are killed and removed during this process, the reduction of the VOCs actually continues for some time after treatment. Placing a filtering system within the structure and/or opening a window to allow the structure 12 to properly vent is believed to be adequate to remove these residual compounds.

In certain instances, the structure 12 is then physically cleaned (124) after the aforementioned steps have been performed. For example, surfaces within the structure may be cleaned in order to remove pest, such as rodent and/or insect, remains and pheromones from the surfaces. Otherwise, the pheromones and even pest remains could yield false positives when testing for adequate treatment, such as when using a gas chromatograph device, canines or the like. Such cleaning may include wiping surfaces, such as hard surfaces with wet wipes, within the structure to remove the pest remains and pheromones from the wiped surfaces. A vacuum having a filter capable of trapping the rodent and/or insect remains and pheromones may also be used to clean the surfaces, and particularly fabrics and soft surfaces. Air from the treated structure may also be passed through a filter, air scrubber, and/or reactor that degrades or destroys the pheromones.

Samples and specimens may be taken of the previously contaminated areas to verify the desired results (126) and a physical examination of the structure can be used to verify the removal of the contagions and harmful substances. The sampling of the air, while heated or when cooler ambient air is introduced and removed, can also be used to verify the results using a high speed gas chromatograph device or the like.

Although the invention has application to rather large structures, such as residential or commercial buildings and passenger occupiable vehicles and the like, the present invention can also be applied to treatment of much smaller areas or objects. For example, a single room of a building may be treated by sealing the windows, doors, and other passageways of that particular room or area and treating such area, as described above. There are also instances where small personal articles, such as clothing or bedding, or even furniture is required to be treated, or a portion of the structure, but not the entire structure itself.

With reference now to FIG. 3, another embodiment of the invention is illustrated which is similar to that described above. However, instead of using an external heater, such as a propane gas tank heater, with inlet ducts, this embodiment utilizes a liquid-to-air heat exchanger device 54 disposed within the enclosure. A heating device 56, preferably a device which is movable or placed on a trailer or the like, heats a liquid, such as water, oil, etc. The heated liquid is then transferred via an inlet conduit 58 into the heat exchanger device 60. Radiator-like fins, fans, etc. can be used to force air over the heat exchanger 60 and cause the air to be heated as it comes into contact with the exterior surfaces of the heat exchanger 60. The now cooler liquid is then returned to the heater 56 through an outlet conduit 62. The conduits 58 and 62 can be linked to multiple heat exchangers 60, or multiple inlet and outlet conduits 58 and 62 can extend from the heater 56 to each heat exchanger 60 so as to sufficiently heat the air within the structure 12. A benefit of this embodiment is that the preparation of the structure 12 is minimized by eliminating the need for ducts and the like. As previously described, however, the system still preferably includes blowers or fans 32 for aggressively moving the air within the structure 12, temperature probes and pressure sensors 18 and 14, as necessary, for monitoring the appropriate temperatures and desired pressure.

As discussed above, when treating structures 12 having dangerous micro-organisms or chemical substances, a negative pressure can be created with a blower 28 attached to an outlet vent 26. An incinerator or filter or reactor 30 can be used to neutralize and destroy these organisms and substances as they are pulled from the structure 12. It will be understood, however, that in other instances there is no need for an outlet duct or conduit 26, filter 30 and blower 28. Instead, a positive pressure is built up within the structures 12 due to the heating of the air by the heat exchanger 54, and the aggressive movement of the air by the blowers and fans 32. In this case, an outlet in the form of an open window or the like can be used to exhaust the heated air from the structure 12.

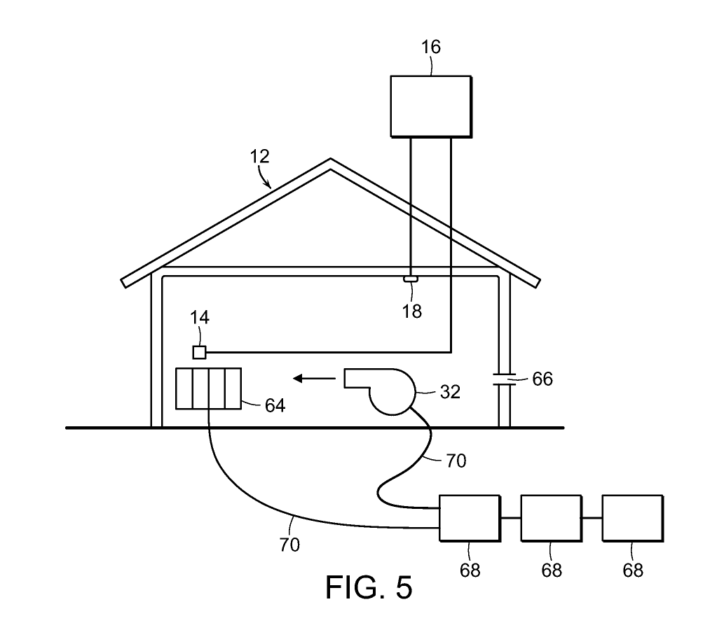

With reference now to FIG. 5, yet another embodiment is shown which is similar to that of FIG. 3. However, instead of a heat exchanger device 54, this embodiment utilizes an electric space heater 64. In this case, one or more electric heaters 64 are selectively positioned within the structure 12 and serve to heat the air therein. Blowers and fans 32 or the like can be used to aggressively move the air past the heating coils of the heater 64 to heat the air, as well as volatilize certain chemicals into the air. By increasing the temperature, and the air movement, the vapor pressure is increased. By increasing vapor pressure, certain chemicals can be volatilized into the air and removed from the building structure 12 and other fixtures or components within the building. The pressure and temperature sensors 14 and 18 are used and connected to a console 16 or otherwise monitored to ensure either the proper negative or positive pressure, as well as the proper temperature range needed for the particular structure 12. In the embodiment illustrated in FIG. 5, there is no outlet duct or conduit or filter. Instead, the outlet 66 is an opening in the structure 12, such as an open door, window, etc. It will be appreciated by those skilled in the art that this presents a significant labor savings when preparing the structure.

There are instances when the electric heaters 64, blowers and fans 32 and other electrical and electronic devices require a source of power that is not present within the structure 12. In some of these instances, for example, heaters which burn fossil fuel cannot be used. For example, when treating offices, condos, apartments or hotel rooms in a multi-story building structure, pressurized propane tanks and the like cannot be brought up in elevators due to safety concerns. In these instances, electric heaters 64 are preferred. However, if the building does not have adequate power or the power cannot be used from the building in order to operate the electrical devices, including the one or more electric heaters 64, the present invention contemplates utilizing multiple portable electric generators 68 which are connected in series with one another so as to increase the overall wattage or electricity output to the electrical devices, such as electric heater 64, blowers 32, etc., such as through power cords 70. The number of electric heaters 64, blowers 32, and other electrical devices may overwhelm a single portable generator and exceed its capacity. Large generators may not be able to be transported into the multi-story building or in other situations. Thus, smaller, portable electric generators could be used in series with one another to meet the electricity demands of the one or more electric heaters 64 and other devices needing electricity during the operation of the invention. These electric generators could be placed, for example, on external patios, separate rooms having open windows or other vents for discharging the fumes generated by the electric generators, etc. It will also be understood that creating a series of interconnected portable electric generators 68 could be advantageous in other situations where they could be placed at ground level, however, purchasing and/or transporting the portable electric generator 68 might be more practical and/or cost effective.

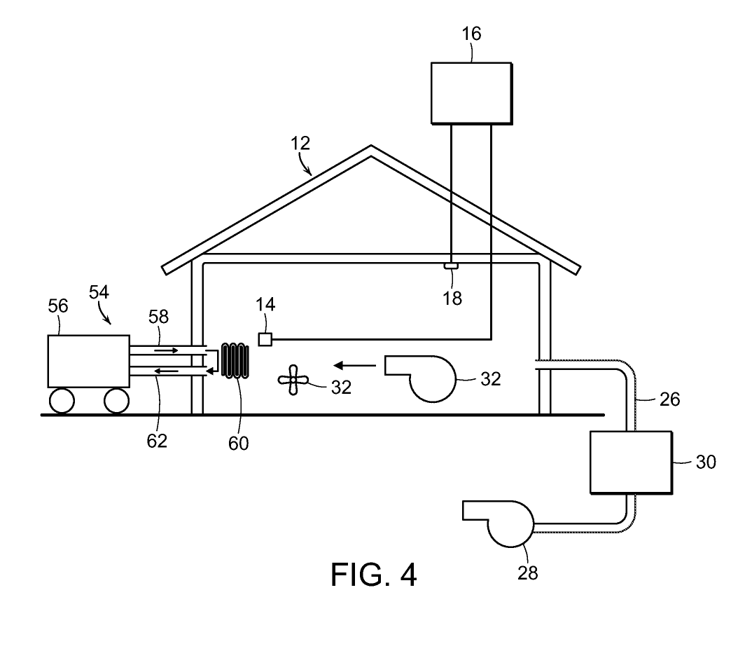

In the embodiments illustrated in FIGS. 1-5, any number of the steps and components illustrated and described can be implemented, as needed. Thus, the entire structure 12 can be sealed and inlet and outlet ducts incorporated. Either positive or negative pressure can be utilized. When dealing with harmful substances, a negative pressure and filter or incinerator 30 are used. However, in many cases, the doors and windows of the building can be closed and sealed the building sufficiently to create an enclosure whereby the air can be heated to the necessary temperature to either kill the micro-organisms, pests, or cause the chemical substances to be released into the heated air for removal. In some instances, certain areas of the structure 12 will be cleaned and pre-treated, such as by applying a biocide (such as boric acid, or the like) scraping and removing sections of walls or flooring having toxic mold and the like, etc. In other cases, these steps may not be necessary. In some cases, the air within the structure 12 need only be heated to between 100° F. to 150° F. However, in other cases, the required temperatures are much higher, such as 200° F. to 400° F.

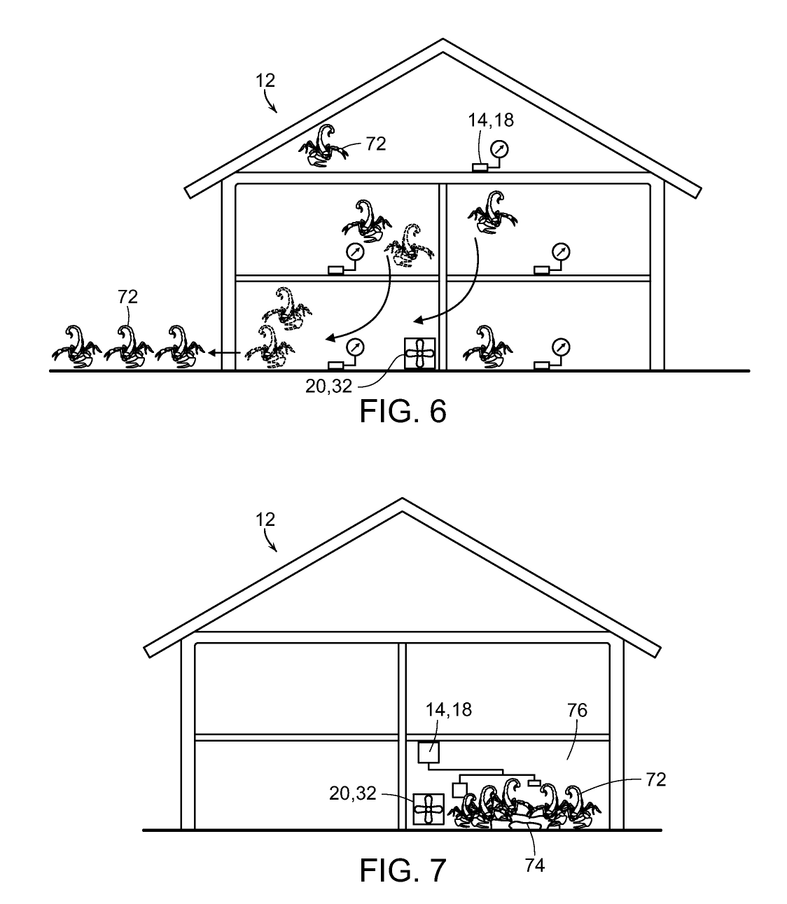

With reference now to FIGS. 6-9, there increasingly exists a significant problem with pest infestation into residential homes and multi-unit buildings, such as hotel and apartment buildings. Pests, such as rodents and insects, including scorpions, fleas, head lice, and particularly bed bugs, find their way through cracks and crevices in the building and aggressively pursue hosts, such as sleeping humans. Bed bugs, blood-sucking parasites, can be introduced in a variety of ways such as by an individual staying in the room, by their pets, or even birds or bats nesting in the eaves of the building, etc. Bed bugs hide in cracks and crevices during the day and come out at night to feed. Such bugs are not limited to the bed, but can be found in stuffed furniture, behind loose wallpaper, under carpet, behind picture frames, in electrical outlets, etc. Thus, merely cleaning or destroying the bed or bedding will not resolve the problem.

Fumigating presents many drawbacks, particularly in a hotel or apartment setting. Although the entire building could be treated, this presents a serious financial drawback for the several days in which the building must be prepared and treated.

With reference now to FIG. 6, a structure 12 is shown infested with pests 72, which can be rodents, insects, including bed bugs, or the like. The structure 12 represents a multi-room residential structure, such as a house or multi-tenant apartment building. The heat treatment process of the present invention, as described above, can be used to kill or drive out the pests 72 from the structure 12. This would involve heating ambient air within the structure to a temperature between 100° F. and 400° F. to kill the pests or drive the pests from the structure. Any manner of the heaters discussed above could be used, and preferably blowers or fans 32 are disposed within the structure so as to distribute the heat. Temperature and/or pressure probes 14, 18 can also be disposed within the structure 12 to monitor the process, as discussed above. Furthermore, biocides, insecticides, metallic salts, diatomaceous earth, silica aerogel or the like can be distributed within the structure 12, and particularly applied to areas where the pests 72 may be residing, such as in cracks, crevices, voids, and other interstitial spaces. These substances can facilitate the killing of the pests, such as by adversely affecting the cuticle or exoskeleton of the insects to make them more susceptible to heat treatment.

The present invention can be used to treat a single room, multiple rooms, or an entire structure, as illustrated in FIG. 6. Probes, such as temperature probes 14 are placed within selected locations within the one or more rooms to be treated, such as between the mattress of the bed and other known bed bug and pest harborages, including under cushions, stuffed furniture, under carpeting, etc. Heaters may be disposed within the room or disposed outside of the room with the necessary ducting being implemented. The air within the structure is heated to a predetermined level which is lethal to the pests. This can cause the pests to die in-situ. Alternatively the pests find ingress/egress points in the structure and flee the structure. During treatment, thermal imaging devices, such as thermal imaging cameras and the like, may be used to detect the ingress/egress points by viewing the pests fleeing the structure or the heated air escaping from such points. These points can then be sealed using calking material and the like to prevent future infestation.

The cracks and crevices can also be sprayed with high temperature forced air from a high temperature hose or a vortex valve, such as illustrated in FIG. 3. The vortex valve is a mechanical device that separates a compressed gas into hot and cold streams. The air emerging from the “hot” end can reach temperatures of 200° C., and the air emerging from the “cold end” can reach −50° C. It has no moving parts. Pressurized gas is injected tangentially into a swirl chamber and accelerated to a high rate of rotation. Due to the conical nozzle at the end of the tube, only the outer shell of the compressed gas is allowed to escape at that end. The remainder of the gas is forced to return in an inner vortex of reduced diameter within the outer vortex. The room is then heated to a predetermined temperature, such as 140° F., for the necessary time. Three hours at this temperature typically kills the bed bugs 72.

With reference now to FIG. 7, an attractant 74 may be used to either attract the pests 72 to a single room or location within the structure 12, so as to enable the treatment of a single room or area 76 of the structure 12. The attractant could be food, water, a chemical substance, a carbon dioxide and/or heat emitter so as to replicate breathing which attracts some pests, such as bed bugs, etc. The one or more attractants 74 could also be used to determine which rooms or areas of the structure 12 are infested. In this manner, only those rooms or areas which are infested need to be treated, not the entire structure. This is particularly advantageous in multi-tenant buildings where there are many apartment or hotel rooms with only some of the rooms being infested and others not being infested. Being able to determine the location of the pests 72 and the areas of infestation enable the hotel or apartment owner to continue to lease or rent out the remaining non-infested rooms, or only provide temporary lodging and the like for those displaced from the rooms or apartments which are infested.

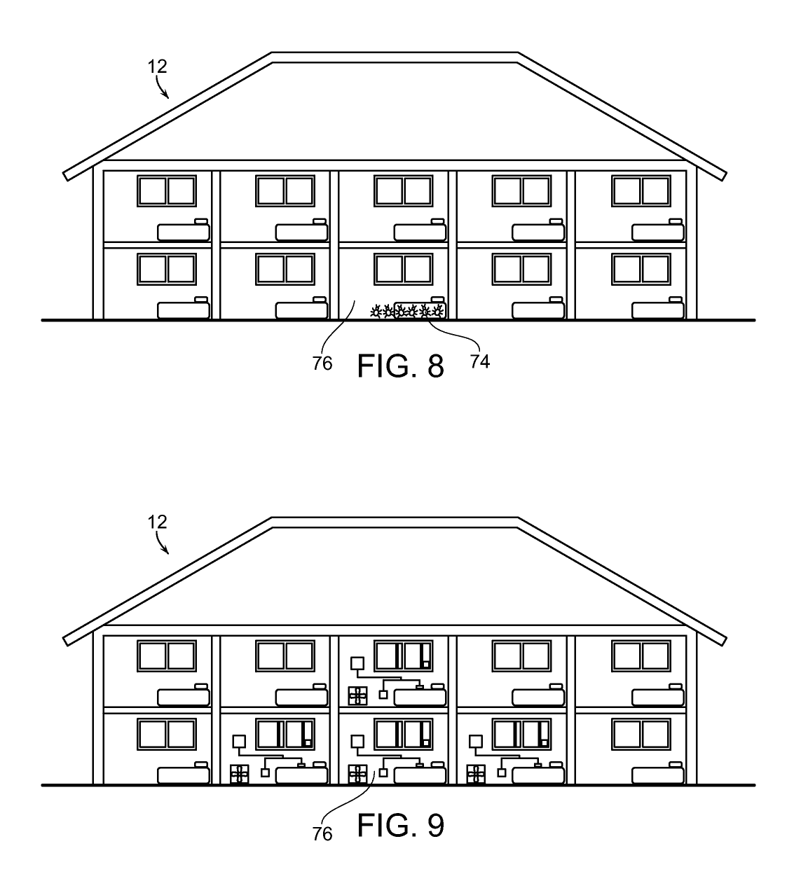

This is diagrammatically illustrated in FIG. 8, wherein a single room 76 of a multi-unit structure 12, such as a hotel or apartment building, is infested with the pests, such as bed bugs. As illustrated in FIG. 9, while the infested room 76 may be treated, the owner of the structure 12 may elect to have rooms immediately adjacent thereto be treated as well as the pests, including bed bugs and the like, can migrate from one room to adjoining rooms, such as through the cracks in the walls, ceiling, etc. Thus, the heaters, blowers, temperature probes, etc. as described above could be positioned within the single infested room 76, or also in those rooms immediately adjacent thereto, as illustrated in FIG. 9 in order to provide greater assurance of the eradication of the bed bugs or other pests.

Multi-tenant managers are anxious to kill bed bugs quickly and inspect for efficacy of the treatment. The inspection may be visual or use gas chromatography or canines. The invention provides a novel approach for slowing the infestation problem quickly. By heating to kill the insects and cleaning to remove pheromones and allow immediate use of the premises. Surfaces within the structure are cleaned to remove the pest remains and pheromones from the surfaces. This may comprise wiping the surfaces, such as with wet wipes. Alternatively, or additionally, the surfaces may be cleaned by vacuuming the surfaces with a vacuum having a filter capable of trapping the pest pheromones. The air from the treated structure may be passed through a filter, air scrubber and/or reactor that captures, degrades or destroys the pheromones. Pheromones persist in the environment if filtration, wet wiping and cleaning are not utilized. If the pheromones are still present the site cannot be cleared for occupation. Bed bugs and other insects often leave pheromones which make it difficult to clear the site particularly if canines are being used. Existing eradication technologies do not utilize pheromone filtration cleaning, and as a result the site must remain unused for extended periods of time. This results in significant additional cost to the building owner. Empty facilities are unable to generate rental income. Conversely, the invention allows for immediate reoccupation of the site because pheromones are degraded or removed at the same time of the abatement. The filtration cleans the air. Wet wiping cleans hard surfaces. HEPA vacuuming cleans soft goods.

Although the rooms can be sealed, and inlet and outlet ducts provided, as described with respect to FIGS. 1 and 2, due to the relatively lower temperatures (130° F.-140° F.) and the non-toxic nature of the killed insects, the rooms need relatively little preparation other than the closing of windows and sealing of door jambs and the like and the installation of the heater and temperature probes. Once the method of the present invention has been used to eradicate the bed bugs, this can typically be done in less than one-day, with no toxic or adverse affects to future customers of the hotel or apartment. The invention can test for the removal of the pheromones and insects or rodents from the treated structure, such as by using a gas chromatograph or canine to test for the removal of the insects, rodents or pheromones from the treated structure. If the pest remains and pheromones are not removed, the gas chromatograph and/or canine could indicate a false positive, preventing future customers of the hotel or apartment from utilizing those rooms or areas of the hotel or apartment building for prolonged periods of time.

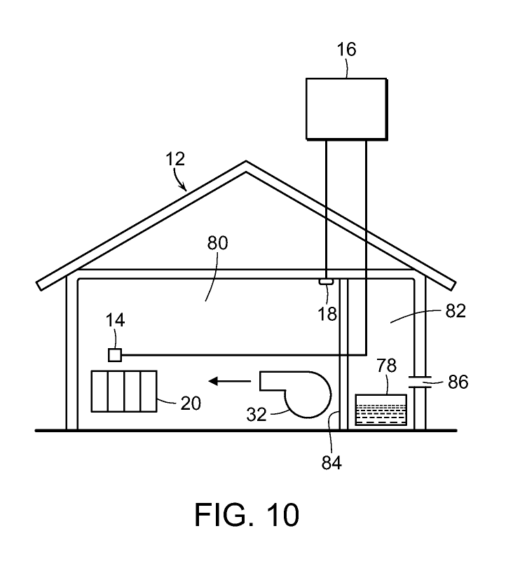

With reference now to FIG. 10, the present invention can also be advantageously used in connection with water damaged buildings. Water damage can result from floods, rain intrusion, broken water or sewer pipes, or backed up sewer pipes or the like. In some cases, only a portion of the structure has water damage. If the water is not removed quickly from the structure, it can extend to other areas of the structure, and mold and bacteria and the like can quickly begin to grow in the humid and wet environment, which can cause health concerns to the occupants of the structure 12.

While the process and method described above in connection with FIGS. 1-5 can be used throughout the entire structure in order heat the air and cause the water within the building materials to migrate into the air and be removed, either through venting, ducting, or by means of a dehumidifier or desiccant device 78, an improved methodology has been discovered which can reduce the time to adequately dry out the building materials and structure by up to 50%.

With reference now to FIG. 10, a structure 12 is shown having a first area 80 having water damage. This area 80 is treated in accordance with the present invention, such as by means of heating the air by a heater 20, or any of the other heaters described above, and aggressively moving the air with a blower 32 and monitoring the temperature, pressure and/or moisture content of the air and building materials, such as using probes 14 and 18 and the like. This process may be monitored and controlled, such as by means of control panel 16, as described above. In accordance with the present invention, a second area 82, adjacent the first area 80 has cooler air therein. This may be ambient air or even air which is air conditioned so as to be cooler than the heated air in the first area 80. Although not illustrated, it will be appreciated that the second area 82 may have the necessary temperature, hygrometer or moisture sensors and the like. Thus, the temperature, moisture content of the air, and/or pressure may also be monitored and controlled in the second area 82.

After creating a temperature and pressure differential between the adjacent first and second areas 80 and 82, by heating the ambient air within the first area 80 of the structure 12, typically to a temperature of between 105° F. and 400° F., moisture is transferred from a boundary 84 between the first and second areas 80 and 82 as the cooler air in the second area 82 comes into contact with the heated air or building materials at the boundary 84 of the first area of the structure 80, causing the air in the second area 82 to heat and draw moisture therein. The heating of the cool air in the second area 82 effectively draws moisture through the boundary 84 (which can comprise a wall, ceiling, floor, etc.) removing moisture from the air and building materials of the first area 80. The wicked or otherwise transferred moisture can then be passed through a dehumidifier or desiccant device 78 and/or burped or flushed out of a vent 86 in the structure 12.

For example, heating a subarea of a structure to a high temperature of between 100° F. and 400° F. and cooling the superstructure by either using ambient air or mechanically conditioned air which is cooler and drier to cause a migration of moisture and speed its removal or capture in dehumidifier equipment 78. This can be done by adding dehumidification or desiccant equipment 78 in the superstructure area, or by burping or flushing the air from the superstructure area to reduce airborne moisture levels and speed the drying process. Measuring devices for temperature and moisture levels may be utilized, whether solid or gas, determining grains per pound of moisture to calculate the best temperature differential for drying used in conjunction with differential heating allows for precise delivery of the process. The temperature and/or pressure may be altered to maximize the transfer of moisture from the first area 80 to the second area 82 of the structure 12. This can also be performed in wall cavity moisture removal and sanitation.

Similar to that described above, heated air may be directed into interstitial locations, such as wall cavities or soffit voids for the purpose of reducing moisture through evaporation and killing microorganisms with elevated temperature. Where the temperatures in interstitial locations exceed temperatures outside or in the second area, the migration of moisture is accelerated to cause the moisture to migrate to drier materials or air according to the second law of thermodynamics.

Although several embodiments have been described in detail for purposes of illustration, various modifications may be made to each without departing from the scope and spirit of the invention. Accordingly, the invention is not to be limited, except as by the appended claims.

What is claimed is:

1. A method for sanitizing a structure of insect and rodent pheromones, comprising the steps of:
heating ambient air within the structure to a temperature of between 100° F. and 400° F. to kill the rodents or insects or drive them from the structure;
cleaning surfaces within the structure to remove pest remains and pheromones from the surfaces;
passing air from the treated structure through a filter and/or reactor that degrades or destroys the pheromones; and
testing for the removal of the pheromones and/or insects or rodents from the treated structure.

2. The method of claim 1, wherein the testing step comprises the step of using a canine to test for the removal of the insects, rodents or pheromones from the treated structure.

3. The method of claim 1, wherein the testing step comprises the step of using a gas chromatograph to test for the removal of the insects, rodents, or pheromones from the treated structure.

4. The method of claim 1, wherein the cleaning step includes the step of wiping surfaces within the structure to remove rodent or insect remains and pheromones from the wiped surfaces.

5. The method of claim 1, including the step of using a vacuum having a filter capable of trapping rodent or insect pheromones to clean surfaces.

6. The method of claim 1, including the step of creating a negative pressure within the structure and passing the air of the treated structure through a filter.

7. The method of claim 1, including the steps of determining one or more locations of insects or rodents within a structure using attractants, and treating the one or more areas of the structure where the insects or rodents are located.

8. The method of claim 1, wherein the heating step includes the step of distributing heated air into the structure using a heater passing heated air through a duct into the structure.

9. The method of claim 1, wherein the heating step includes the step of placing a heater device within the structure.

10. The method of claim 1, wherein the heating step includes the step of blowing high pressure, heated air into cracks, crevices and voids to flush out or kill the insects or rodents residing therein.

11. The method of claim 10, wherein a vortex tube is used to inject hot, pressurized air into the cracks, crevices and voids.

12. The method of claim 1, including the step of positioning one or more of temperature or moisture probes at locations to monitor the temperature in the structure until the temperature of between 100° F. and 400° F. is achieved.

13. The method of claim 1, including the step of dispersing a biocide or metallic salt within the structure prior to or after the heating step.

14. The method of claim 1, wherein the insects comprise bed bugs.

15. A method for removing moisture from a water damaged structure, comprising the steps of:
creating a temperature and pressure differential between adjacent first and second areas of the structure by heating ambient air within the first area of the structure to a temperature of between 105° F. and 400° F.;
measuring the temperature in the first and second areas;
transferring moisture from a boundary of the first area to the second area of the structure as cooler air in the second area comes into contact with heated air or building materials of the first area of the structure, causing the air in the second area to heat and draw moisture therein; and
removing moisture from the air of the second area by evacuating air from the second area from the structure and/or passing the air from the second area through a dehumidifier or desiccant.

16. The method of claim 15, wherein the heating step includes the step of distributing heated air into the first area of the structure using a heater passing heated air through a duct into the structure or a heater device within the structure.

17. The method of claim 15, wherein the heating step includes the step of directing heated air into wall cavities or soffit voids to reduce moisture through evaporation.

18. The method of claim 17, wherein a vortex tube is used to inject hot, pressurized air into the cracks, crevices and voids.

19. The method of claim 15, including the step of killing microorganisms resulting from the water damage with the heated air.

20. The method of claim 15, including the step of applying a biocide or metal salt to areas of the structure contaminated with microorganisms.

21. The method of claim 15, including the step of positioning one or more of temperature or moisture probes at locations to monitor the temperature or moisture content of the air.

22. The method of claim 21, including the step of altering the temperature or pressure to maximize the transfer of moisture from the first area to the second area of the structure.

23. A method for treating a contaminated or water damaged structure, comprising the steps of:
providing at least one heater for heating the interior of the structure;
providing a plurality of portable electric generators coupled to one another in series so as to provide sufficient electricity to the at least one heater; and
heating ambient air within the structure to a temperature of between 105° F. and 400° F. for a period of time to treat the contamination and/or kill insects in the structure.

24. The method of claim 23, wherein the heating step includes the step of distributing heated air into the structure using a heater passing heated air through a duct into the structure.

25. The method of claim 23, wherein the heating step includes the step of placing a heater device within the structure.

26. The method of claim 23, wherein the heating step includes the step of blowing high pressure, heated air into cracks, crevices and voids.

27. The method of claim 26, wherein a vortex tube is used to inject hot, pressurized air into the cracks, crevices and voids.

28. The method of claim 23, including the step of positioning one or more of temperature or moisture probes at locations to monitor the temperature in the structure until the temperature of between 105° F. and 400° F. is achieved.

29. The method of claim 23, wherein the contaminant comprises mercury, which is aerosolized by the heat treatment and captured by a filter.

30. A method for treating a structure contaminated with insects or microorganisms, comprising the steps of:
applying a metallic salt to areas within the structure infested with the insects or microorganisms; and
heating ambient air within the structure to a temperature of between 105° F. and 400° F. to kill the insects or microorganisms or drive the insects from the structure.

31. The method of claim 30, wherein the heating step includes the step of distributing heated air into the structure using a heater passing heated air through a duct into the structure.

32. The method of claim 30, wherein the heating step includes the step of placing a heater device within the structure.

33. The method of claim 30, wherein the heating step includes the step of blowing high pressure, heated air into cracks, crevices and voids.

34. The method of claim 33, wherein a vortex tube is used to inject hot, pressurized air into the cracks, crevices and voids.

35. The method of claim 30, including the step of positioning one or more of temperature or moisture probes at locations to monitor the temperature in the structure until the temperature of between 105° F. and 400° F. is achieved.
